(19) United States
(12) Patent Application Publication
(10) Pub. No.: US 2020/0070776 A1
(43) Pub. Date: Mar. 5, 2020

(54) Method for exchanging data between a vehicle and an infrastructure or a further vehicle

(71) Applicant: Ford Global Technologies, LLC, Dearborn, MI (US)

(72) Inventors: Frederic Stefan, Aachen (DE); Christoph Arndt Dr habil, Moerlen (DE); Uwe Gussen, Huertgenwald (DE)

(73) Assignee: Ford Global Technologies, LLC, Dearborn, MI (US)

(21) Appl. No.: 16/557,436

(22) Filed: Aug. 30, 2019

(30) Foreign Application Priority Data
Aug. 30, 2018 (DE) 102018214735.3

(51) Int. Cl. B60R 25/24; B60Q 1/00; H04W 12/04; H04W 12/06; H04W 4/44

(52) U.S. Cl. CPC B60R 25/24; B60Q 1/0017; H04W 12/04; B60R 2325/205; H04W 4/44; B60R 2325/108; H04W 12/0609

(57) ABSTRACT

Method for the encrypted exchange of data between a vehicle and an infrastructure or a further vehicle using headlamp light of the vehicle, wherein the data are encrypted and modulated onto the headlamp light in order to identify the user and/or the vehicle, wherein the key for encrypting the data is generated by user-controlled transformation.

The invention relates to a method for exchanging data between a vehicle and an infrastructure or a further vehicle according to claim 1.

Car-to-Car communication (Car2Car or C2C), also commonly referred to as Vehicle-to-Vehicle (V2V), designates the exchange of information and data between motor vehicles in the context of alerting the driver in a timely manner to critical and hazardous situations. Various projects have been set up in Europe for this purpose, all ultimately seeking to increase traffic safety and optimize traffic flow. Car2Car is a special case of Car2X, entailing the communication of vehicles with their environment (along with other road users, in particular the infrastructure).

Partially or fully automated vehicles (AV vehicles) need to exchange a constantly increasing quantity of data with their environment (other vehicles, pedestrians, bicycles, infrastructures, etc.). The exchanged data can be used for various purposes, such as e.g. the exchange of status information (speed, etc.) between vehicles in order to enable automated driving, or the exchange of authentication data in order to actuate a barrier, garage door, highway payment facility, etc.

The communication between the automobile and its environment should generally be performed via V2x communication. V2X uses DSRC (Dedicated Short Range Communication) devices which operate in the 5.9 GHz band with a range of around 1000 m.

In some cases, it may be appropriate to uniquely identify a vehicle and/or its driver in order to make V2X robust in terms of encryption and man-in-the-middle attacks.

In addition, the authentication method can become indispensable for the development of an intelligent mobility solution with automated driving in order to enable an AV vehicle to automatically open an exit gate of a garage with parking charges or to automatically open gates at a payment point on the highway or simply to enable the infrastructure to recognize that an automobile is authorized to perform specific actions (e.g. priority vehicles, police, fire department, etc.). In some cases, it may also be appropriate to identify the driver of a vehicle, e.g. for car sharing applications.

It is known from US 2014/0099107 A1 to use light from vehicles invisible to the human eye for the transmission of modulated information, if necessary in encrypted form, in order to identify or authenticate the user or the vehicle.

In order to prevent an intentional corruption or manipulation of the transmitted information, it is necessary to code and also to encrypt the information.

The invention comes into play here and sets itself the object of providing a secure but simple method for exchanging data between a vehicle and an infrastructure or a further vehicle using light.

This object is achieved by the method set out in claim 1. Advantageous designs can be found in the subclaims and the description.

It has been recognized according to the invention that, if a method for the encrypted exchange of data between a vehicle and an infrastructure or a further vehicle is carried out using headlamp light of the vehicle, wherein the data are encrypted and modulated onto the headlamp light in order to identify the user and/or the vehicle, wherein the key for encrypting the data is generated by user-controlled transformation, it is possible in a simple manner to provide a particularly secure communication.

A method of this type wherein the user-controlled transformation comprises an image transformation or video transformation is particularly simple and clear for the users.

Matrix headlamp light has been found to be particularly suitable, since it permits a high information density in the modulation. In particular, matrix LED or matrix laser headlamp light should be used.

The use of further light technologies such as laser matrix, OLED, beamer, FlexDisplay and liquid light would also be conceivable.

The key can be exchanged periodically and/or on request with the infrastructure or with the further vehicle, preferably using the handshake method.

A visual check of the key can be performed according to the invention.

The exchanged data can additionally have an identification code for the vehicle and/or the user and/or a procedure.

The user-controlled transformation can be performed e.g. on a touch display, wherein the user “draws” or performs random movements with his finger on said display. Said movements could then be displayed as “brush strokes” in an image as the transmission medium, allowing a simple visual check.

In other words, a visual vehicle authentication is enabled by the present invention by means of 2D/3D “images” which are transmitted via the vehicle headlamps, and in particular LED matrices, used as spotlights.

The operating principle consists in the definition by the driver of a 2D/3D image or video signature/password with a special device in the vehicle (HMI, smartphone, SYNC, entertainment etc.).

Here, a video signature/password would mean that the driver would define a signature/password on a sequence of images.

This signature or password can be converted into a first set of data or bits (and can serve as a key) representing the encrypted key version of the signature.

This may be a complex transformation of the image or it may simply be a matrix of “bits” (or a sequence of matrices of bits) corresponding to the 2D/3D image signature/password defined by the driver/user.

This signature or key is then converted into a set of specific (LED) headlamp matrix control commands in order to generate a 2D or 3D light pattern or a sequence of 2D or 3D light patterns which would be transmitted in the form of a time pattern.

The control commands could entail:
the precise control of one or more elements of the matrix, e.g. LEDs or LED matrix;
the control of the (LED) intensity;
the control of the (LED) orientation;
the control of the (LED) frequency;
the triggering of a light polarization effect.

In other words, the modulation of the data onto the headlamp light can comprise any possible variation of the light, in particular those which are invisible to the human eye.

In one preferred embodiment, the modulation of the light (in particular the LED matrix) is therefore intended to be neither visible nor perceptible to the human eye.

The visual signature thus generated in the light can be defined once by the driver at home or in the vehicles and can be loaded onto vehicles, e.g. with a portable smartphone. The system can request a regular change of the visual signature by the driver.

The visual signature can then be used differently by the authentication system, e.g. for exchanging data between the vehicle and the infrastructure (V2I), as a data encryption key or for exchanging encrypted data, for V2I authentication to activate a procedure or service or as V2I backup data communication.

The driver's own vehicle and the infrastructure or further vehicle in each case preferably comprise a sensor which enables the reception and decoding of the light signal from headlamps of other vehicles or infrastructure.

These sensors can comprise detectors, cameras, camera sensors, special dual LEDs which are capable of emitting and transmitting light, etc. Furthermore, a sensor of this type can also be integrated into the headlamp itself.

Headlamp sensors of this type could be used for exchanging data between vehicles and/or infrastructure in order to receive a V2I encryption key or a V2I authentication pattern or specific redundant data.

All possibilities can be considered as infrastructure. This may therefore comprise e.g. services for the vehicle and/or its occupants, e.g. highway payment, toll fee payment, garage opening, drive-in restaurant ordering and/or payment, payment and opening of parking garages, opening of parcel packaging centers, etc.

The user-controlled transformation for the key generation can be performed, as mentioned, on a touch display. A device such as an intelligent portable device (smartphone, notebook, tablet), a fixed terminal (PC), in a vehicle or via a dedicated HMI (human-machine interface), an entertainment system, a display with a touchscreen or gesture recognition can be used, enabling the driver or occupants to define a static 2D/3D image signature (i.e. a pattern) or to define a sequence of 2D/3D image signatures (i.e. video signatures).

The image signatures consist e.g. of one or a sequence of X, Y, (Z) cloud points in each case for a static image signature or a video signature.

The visual signature (key) can be stored as a 2D/3D cloud point or as a sequence of cloud points.

The key or signature can be stored permanently in a memory in order to enable the upload onto an external system. The user could, for example, store his image signature on a USB stick or the memory of his smartphone and could load it into the vehicle. Alternatively, the key could also be directly stored in the vehicle and, optionally, could also be paired with a vehicle identification.

The inventive concept also encompasses the conversion of the encryption code and the authentic pattern into instructions for the headlamp control.

In one possible, simple implementation, the control algorithm for an LED matrix headlamp would convert an N×1 bit encryption key into an N×P matrix with a 1×P transformation. Each cell of the N×P matrix enables the control of the intensity of one of the N×P LEDs of the headlamp and can contain 1 or 0. In this case, it would be appropriate to choose a length N for the encryption key which matches a dimension of the LED matrix of the headlamp. The 0 and 1 do not mean that every LED would be ON or OFF, but e.g. every LED could be switched on with a first intensity or a second intensity. This would enable the superimposition of a visual message while the headlamps are activated during nighttime driving.

The generation of the encryption key can be performed in a module which allows the image signature or video signature to be converted into a group of bits/bytes which are used as the encryption key.

The group may be a matrix which is derived directly from the image signature (e.g. M×N cloud points) or a one-dimensional (e.g. M×1) bit encryption key which is obtained by applying a matrix transformation to the image signature (e.g. an N×1 transformation). In this case, the key could be an SSL key. The key may also be a sequence of a plurality of keys in the case of a video signature.

The generation of authentication patterns can be used as an extension of the encryption key in the case where the vehicle must or wishes to authenticate itself to an infrastructure. In this case, the key (encryption key) would be combined with a further identification code, typically a T×1 bit sequence. This could be:

1 an identifier of the vehicle (e.g. license number, chassis number, etc.);
an identifier of a banking transaction or other procedure;

1 an identifier of a driving authorization (e.g. to park at a specific location, etc.).

The authentication pattern generation can be performed in different ways:
attachment of the identification code to the key;
vector product (or other suitable mathematical transformation) of the identification code with the key;
bit filling, insertion of the identification code bit-by-bit between the bits of the encryption key.

The invention also enables a backup data transmission to the otherwise conventional radio transmission for V2I communication. The specific information relating to the state of the vehicle and the intention of the driver, normally supplied via V2I radio communication, can thus be transmitted using the matrix of the headlamps. This can be done for reasons of data redundancy or in emergency situations, e.g. if a critical drive situation arises, or the V2I system is damaged or partially damaged. Information relating to the vehicle state can thus be transmitted in this mode via the headlamp communication channel for data redundancy purposes, in an emergency, for a data backup in the event of V2I failure or partial failure or in a critical drive situation.

The mode of operation is then similar to the transmission of the encryption key or authentication key. The vehicle state information can be converted into headlamp commands and can be emitted via the headlamps.

According to the invention, requests can be transmitted and received in order to set up an encrypted data communication with surrounding vehicles or infrastructures. This request can be transmitted via V2I and, if a request is transmitted or received, the system can transmit the encryption key via light modulation. This process can take place periodically.

Alternatively, the encryption key can be transmitted regularly via the headlamps and the communication can always be encrypted.

Alternatively, an encryption of the communication can be performed in a specific environment (e.g. heavy data traffic or densely built-up area) or in a specific area in which the risk of a cyberattack would be higher.

As mentioned, data encryption keys can be captured and read by suitable optical sensors.

According to the invention, the data transmitted by the vehicle are encrypted with the encryption key which is generated from the user-controlled transformation. Nearby vehicles or infrastructure which are capable of receiving and reading the key can decode and use the data. Conversely, the vehicle can record a plurality of external encryption keys using the headlamps and can attempt to decrypt the entire incoming V2I communication with the list of available encryption keys.

It is furthermore conceivable to activate the authentication operation, i.e. the encryption, in special drive situations.

This mode can comprise e.g. the following sub-steps:
A situation occurs in which an authentication is recognized as required, e.g. by an infrastructure request, GPS data, etc.
In some cases, a special identifier or enabler is requested for the authentication. In this case, the infrastructure transmits a first identifier. If this is not the case, an authentication code can be generated directly (see below).
The vehicle receives the authentication request and optionally the first identifier for a specific transaction (e.g. payment). The vehicle instigates the transaction.
The transaction platforms transmit a second identifier back to the vehicle and the infrastructure.
An authentication code is then generated using the encryption key and either a second identifier or driver-specific or vehicle-specific identifier (ID card, license number, etc.).
The authentication code is then transmitted to the infrastructure which can release the service (e.g. the authentication code can be previously stored in the infrastructure or can be processed by the infrastructure in a similar manner as in the vehicle by using the second identifier).

Further details of the invention can be found in the following description of example embodiments with reference to the drawing, in which:

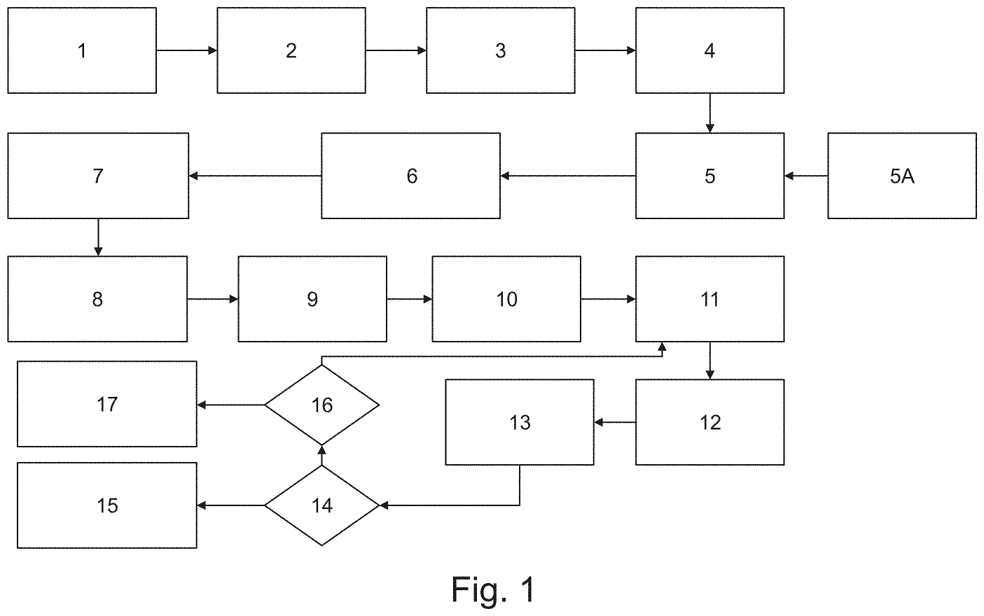

FIG. 1 shows a flow diagram of the interaction between a vehicle and an infrastructure according to the invention.

FIG. 1 explains on the whole a method for the encrypted exchange of data between a vehicle and an infrastructure using headlamp light of the vehicle. The data are encrypted and modulated onto the headlamp light in order to identify the user and the vehicle, wherein the key for encrypting the data is generated by user-controlled transformation.

It specifically describes the interaction between a passenger vehicle and an infrastructure in the form of a highway barrier in order to open the barrier after a payment has been made.

In the example, all communications are performed by means of light signal transmission via vehicle headlamps and light sensors of the respective infrastructure or via light signals from the infrastructure and light sensors on the vehicle. Alternatively, a wireless radio transmission could also be used for the infrastructure-to-vehicle communication.

In the present example, a 2D image signature of the driver is requested in order to generate the encryption key of the passenger vehicle (encryption key of the vehicle (EKV)).

The 2D image signature is generated by the driver by “doing some drawing” on a touch display on which an image is displayed, thus generating an image signature as a first set of data or bits.

In the example, a handshake method is described in which the infrastructure and the vehicle first exchange their keys (their encryption keys). The method offers the advantage that the keys can be changed during each communication, e.g. by using a different 2D image signature.

This increases security against spying.

The method proceeds as follows.

The passenger vehicle drives on the highway and approaches a toll barrier. The toll barrier recognizes this (1) and then transmits, on the one hand, its own key and a request for the passenger vehicle key (2).

The passenger vehicle checks (3) the key of the toll barrier via a wireless Internet connection and, in the event of a positive check, the key of the toll barrier is stored in the passenger vehicle and is saved for the further communication decryption in the passenger vehicle (4).

The passenger vehicle then transmits its key via the headlamp modulation (5). The key has previously been generated by the driver by drawing a pattern on an image shown on a touch display of the passenger vehicle (5A).

The toll barrier receives and temporarily stores the key of the passenger vehicle (6) and then uses it to decrypt the communication with the passenger vehicle.

The toll barrier then transmits an encrypted request to the passenger vehicle to furnish evidence of the paid toll, whereupon the passenger vehicle can then decrypt said request (7).

The passenger vehicle contacts a bank via a wireless Internet connection (8) to make the payment, wherein the passenger vehicle transmits its key (from above) for the authorization (9).

The bank then effects the transfer (10) and transmits a transaction code as confirmation.

The passenger vehicle generates (11) a response to the payment request from its key and the transaction code (7) and transmits it encrypted in this way via the headlamps to the toll barrier (12).

The toll barrier extracts the transaction code and checks it with the bank via a wireless Internet connection (13).

If the transaction code is valid (14), the barrier opens (15).

If the transaction code is invalid (16), a transmission fault is checked (distance too great, etc.). If a fault is present, the vehicle is requested to retransmit the transaction code (return to 11).

If no fault is present, the passenger vehicle is notified that only a manual toll barrier processing is possible, so that the passenger vehicle must be relocated.

1. A method for the encrypted exchange of data between a first vehicle and an infrastructure or a second vehicle using a headlamp light of the first vehicle, the method comprising:
encrypting the data,
modulating the data onto the headlamp light,
identifying, based on modulating the data, the first vehicle, and
generating a key for encrypting the data by user-controlled transformation.

2. The method according to claim 1, wherein the user-controlled transformation comprises an image or video transformation.

3. The method according to claim 1, wherein the headlamp comprises a matrix LED or a matrix laser headlamp light.

4. The method according to claim 1, wherein the key is exchanged periodically and/or on request with the infrastructure or the second vehicle.

5. The method according to claim 2, further comprising conducting a visual check of the key.

6. The method according to claim 1, wherein the data additionally have an identification code for the first vehicle.

7. The mefhod according to claim 1, wherein the user-controlled transformation takes place on a touch display.

8. A vehicle, comprising:
a headlight;
a human machine interface (HMI); and
a computing device configured to:
determine, based an image signature on the HMI, a key,
receive a communication from an infrastructure component or a second vehicle, and
transmit, based on the communication from the infrastructure component or the second vehicle and via light emitted by the headlight, the key to the infrastructure component or the second vehicle.

9. The vehicle of claim 8, wherein image signature comprises a user-controlled transformation comprising an image or video transformation.

10. The vehicle of claim 8, wherein the headlight comprises a matrix LED or a matrix laser headlamp light.

11. The vehicle of claim 8, wherein the vehicle is configured to conduct a visual check of the key.

12. The vehicle of claim 8, wherein the key comprises an identification code for the vehicle.
